(19) United States
(12) Patent Application Publication
(10) Pub. No.: US 2013/0294250 A1
(43) Pub. Date: Nov. 7, 2013

(54) EXCHANGING DATA BETWEEN A USER EQUIPMENT AND ONE OR MORE SERVERS OVER A COMMUNICATIONS NETWORK

(71) Applicant: QUALCOMM ISKOOT, INC., San Diego, CA (US)

(72) Inventors: Gabriel BERELEJIS, Bet Shemesh, IL (US); Eitan Mizrotsky, Jerusalem (IL); Vivek Raman, San Francisco, CA (US); Mark Williams Jacobstein, San Francisco, CA (US); Wayne Fenton, San Francisco, CA (US)

(73) Assignee: Qualcomm iSkoot, Inc., San Diego, CA (US)

(21) Appl. No.: 13/874,210

(22) Filed: Apr. 30, 2013

Related U.S. Application Data
(60) Provisional application No. 61/641,185, filed on May 1, 2012.

(51) Int. Cl. H04L 12/70

(52) U.S. Cl. CPC H04L 47/193
USPC 370/236

(57) ABSTRACT

In an embodiment, a proxy server delivers, to a UE, a set of rules to be enforced by a management application executing thereon. The set of rules includes at least one rule that instructs the management application to selectively intercept and apply data payload modifications to data being exchanged being a transport layer stack (e.g., a TCP/IP stack) and one or more client applications on the UE based on (i) a packet-state related to a data payload of the data (ii) a device-state associated with the UE, (iii) an application-state associated with an application from which the data originates or to which the data is targeted and/or (iv) a network-state associated with a serving network of the UE. The management application on the UE can enforce the set of rules for UE-terminated data (e.g., data downloaded to the UE) or UE-originated data (e.g., data to be uploaded from the UE).

### CLAIM OF PRIORITY UNDER 35 U.S.C. §119

The present Application for Patent claims priority to Provisional Application No. 61/641,185 entitled “EXCHANGING DATA BETWEEN A USER EQUIPMENT AND ONE OR MORE SERVERS OVER A WIRELESS COMMUNICATIONS NETWORK”, filed May 1, 2012, by the same inventors as the subject application, assigned to the assignee hereof and hereby expressly incorporated by reference herein.

### BACKGROUND OF THE INVENTION

1. Field of the Invention

Embodiments relate to exchanging data between a user equipment and one or more servers over a communications network.

2. Description of the Related Art

Bandwidth over communications systems, such as wireless communications systems, can be expensive or limited. Conventional mechanisms for reducing bandwidth consumption of a subscriber device include diverting the subscriber device to cheaper protocols (e.g., WiFi), accessing the wireless communication systems during off-peak hours and so on.

### SUMMARY

In an embodiment, a proxy server delivers, to a user equipment (UE), a set of rules to be enforced by a management application executing thereon. The set of rules includes at least one rule that instructs the management application to selectively intercept and apply data payload modifications to data being exchanged being a transport layer stack (e.g., a TCP/IP stack) and one or more client applications on the UE based on (i) a packet-state related to a data payload of the data (ii) a device-state associated with the UE, (iii) an application-state associated with an application from which the data originates or to which the data is targeted and/or (iv) a network-state associated with a serving network of the UE. The management application on the UE can enforce the set of rules for UE-terminated data (e.g., data downloaded to the UE) or UE-originated data (e.g., data to be uploaded from the UE).

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 is a diagram of a wireless network architecture that supports access terminals and access networks in accordance with at least one embodiment of the invention.

FIG. 2 illustrates a core network according to an embodiment of the present invention.

FIG. 3 is an illustration of a given user equipment (UE) in accordance with at least one embodiment of the invention.

FIG. 4A illustrates a communication device that includes logic configured to perform functionality in accordance with an embodiment of the invention.

FIG. 4B illustrates a server in accordance with an embodiment of the invention.

FIG. 5 illustrates a client-server architecture in accordance with an embodiment of the present invention.

FIG. 6 illustrates an example of rule generation at a Mobile Optimized Data (MOD) server and distribution to a Proxy On Device (POD) module in accordance with an embodiment of the invention.

FIG. 7A illustrates an example execution of the POD-enforceable rules at the given UE for UE-originated traffic in accordance with an embodiment of the present invention.

FIG. 7B illustrates another example execution of the POD-enforceable rules at the given UE for UE-originated traffic in accordance with an embodiment of the present invention.

FIG. 8 illustrates an example execution of the POD-enforceable rules at the given UE for UE-terminated traffic in accordance with an embodiment of the present invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A High Data Rate (HDR) subscriber station, referred to herein as user equipment (UE), may be mobile or stationary, and may communicate with one or more access points (APs), which may be referred to as Node Bs. A UE transmits and receives data packets through one or more of the Node Bs to a Radio Network Controller (RNC). The Node Bs and RNC are parts of a network called a radio access network (RAN). A radio access network can transport voice and data packets between multiple access terminals.

The radio access network may be further connected to additional networks outside the radio access network, such core network including specific carrier related servers and devices and connectivity to other networks such as a corporate intranet, the Internet, public switched telephone network (PSTN), a Serving General Packet Radio Services (GPRS) Support Node (SGSN), a Gateway GPRS Support Node (GGSN), and may transport voice and data packets between each UE and such networks. A UE that has established an active traffic channel connection with one or more Node Bs may be referred to as an active UE, and can be referred to as being in a traffic state. A UE that is in the process of establishing an active traffic channel (TCH) connection with one or more Node Bs can be referred to as being in a connection setup state. A UE may be any data device that communicates through a wireless channel or through a wired channel. A UE may further be any of a number of types of devices including but not limited to PC card, compact flash device, external or internal modem, or wireless or wireline phone. The communication link through which the UE sends signals to the Node B(s) is called an uplink channel (e.g., a reverse traffic channel, a control channel, an access channel, etc.). The communication link through which Node B(s) send signals to a UE is called a downlink channel (e.g., a paging channel, a control channel, a broadcast channel, a forward traffic channel, etc.). As used herein the term traffic channel (TCH) can refer to either an uplink/reverse or downlink/forward traffic channel.

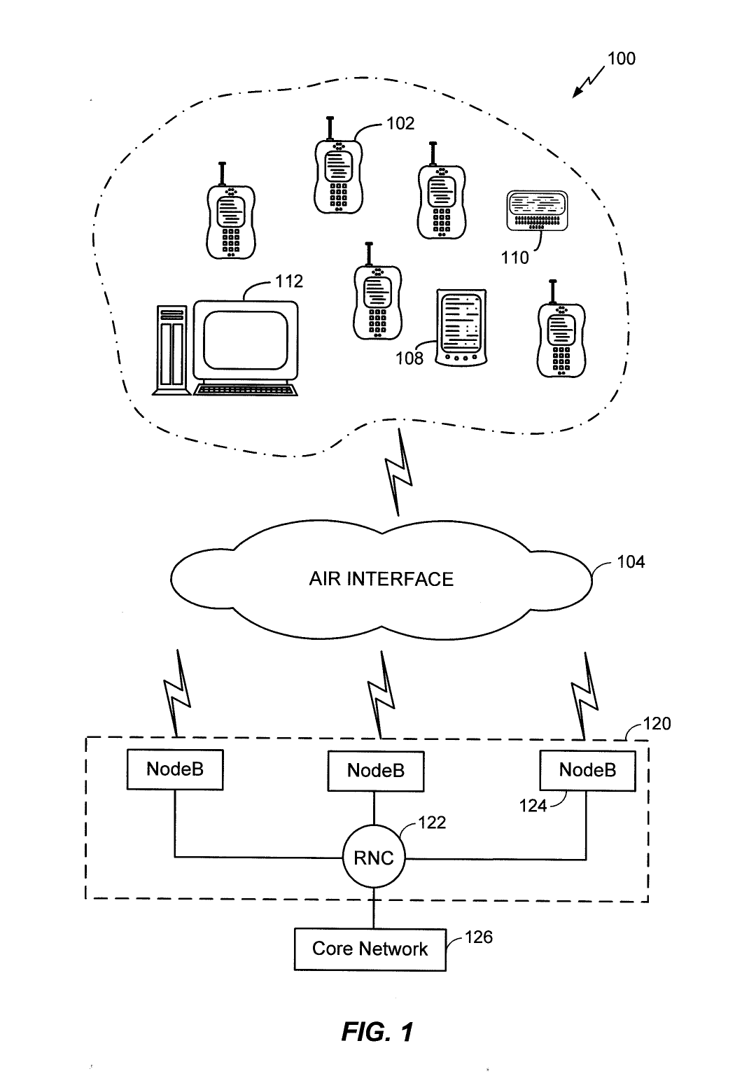

FIG. 1 illustrates a block diagram of one exemplary embodiment of a wireless communications system 100 in accordance with at least one embodiment of the invention. System 100 can contain UEs, such as cellular telephone 102, in communication across an air interface 104 with an access network or radio access network (RAN) 120 that can connect the UE 102 to network equipment providing data connectivity between a packet switched data network (e.g., an intranet, the Internet, and/or core network 126) and the UEs 102, 108, 110, 112. As shown here, the UE can be a cellular telephone 102, a personal digital assistant or tablet computer 108, a pager or laptop 110, which is shown here as a two-way text pager, or even a separate computer platform 112 that has a wireless communication portal. Embodiments of the invention can thus be realized on any form of UE including a wireless communication portal or having wireless communication capabilities, including without limitation, wireless modems, PCMCIA cards, personal computers, telephones, or any combination or sub-combination thereof. Further, as used herein, the term “UE” in other communication protocols (i.e., other than W-CDMA) may be referred to interchangeably as an “access terminal,” “AT,” “wireless device,” “client device,” “mobile terminal,” “mobile station” and variations thereof.

Referring back to FIG. 1, the components of the wireless communications system 100 and interrelation of the elements of the exemplary embodiments of the invention are not limited to the configuration illustrated. System 100 is merely exemplary and can include any system that allows remote UEs, such as wireless client computing devices 102, 108, 110, 112 to communicate over-the-air between and among each other and/or between and among components connected via the air interface 104 and RAN 120, including, without limitation, core network 126, the Internet, PSTN, SGSN, GGSN and/or other remote servers.

The RAN 120 controls messages (typically sent as data packets) sent to a RNC 122. The RNC 122 is responsible for signaling, establishing, and tearing down bearer channels (i.e., data channels) between a Serving General Packet Radio Services (GPRS) Support Node (SGSN) and the UEs 102/108/110/112. If link layer encryption is enabled, the RNC 122 also encrypts the content before forwarding it over the air interface 104. The function of the RNC 122 is well-known in the art and will not be discussed further for the sake of brevity. The core network 126 may communicate with the RNC 122 by a network, the Internet and/or a public switched telephone network (PSTN). Alternatively, the RNC 122 may connect directly to the Internet or external network. Typically, the network or Internet connection between the core network 126 and the RNC 122 transfers data, and the PSTN transfers voice information. The RNC 122 can be connected to multiple Node Bs 124. In a similar manner to the core network 126, the RNC 122 is typically connected to the Node Bs 124 by a network, the Internet and/or PSTN for data transfer and/or voice information. The Node Bs 124 can broadcast data messages wirelessly to the UEs, such as cellular telephone 102. The Node Bs 124, RNC 122 and other components may form the RAN 120, as is known in the art. However, alternate configurations may also be used and the invention is not limited to the configuration illustrated. For example, in another embodiment the functionality of the RNC 122 and one or more of the Node Bs 124 may be collapsed into a single “hybrid” module having the functionality of both the RNC 122 and the Node B(s) 124.

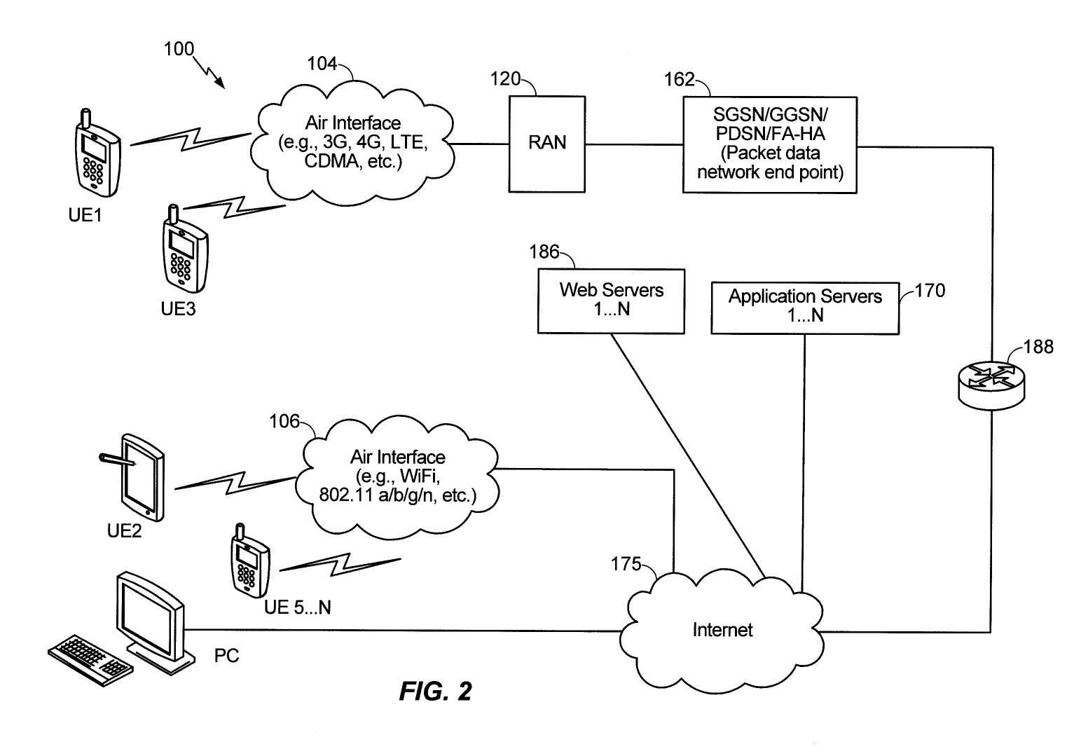

FIG. 2 illustrates an example of the wireless communications system 100 of FIG. 1 in more detail. In particular, referring to FIG. 2, UEs 1 . . . N are shown as connecting to the RAN 120 at locations serviced by different packet data network end-points. The illustration of FIG. 2 is specific to W-CDMA systems and terminology, although it will be appreciated how FIG. 2 could be modified to conform with various other wireless communications protocols (e.g., LTE, EV-DO, UMTS, etc.) and the various embodiments are not limited to the illustrated system or elements.

UEs 1 and 3 connect to the RAN 120 at a portion served by a first packet data network end-point 162 (e.g., which may correspond to SGSN, GGSN, PDSN, a home agent (HA), a foreign agent (FA), PGW/SGW in LTE, etc.). The first packet data network end-point 162 in turn connects, via the routing unit 188, and through the routing unit 188, to the Internet 175. Through the Internet 175, the UEs 1 and 3 can connect to any of application servers 1 . . . N 170 that are configured to provide one or more Internet-based services (e.g., streaming video, etc.). Also, through the Internet 175, UEs 1 and 3 can connect to any of web servers 1 . . . N (e.g., providing web-content or web browsing features), 186. UEs 2 and 5 . . . N connect to the Internet 175 via a different air interface 106, such as a WiFi or IEEE 802.11 a/b/g/n interface via a local wireless access point or hotspot. UE 4 connects directly to the Internet 175 via a wired connection (e.g., a LAN or Ethernet connection), and through the Internet 175 can then connect to any of the system components described above.

Referring to FIG. 2, UEs 1, 3 and 4 . . . N are illustrated as wireless cell-phones, UE 2 is illustrated as a wireless tablet-and/or laptop PC. However, in other embodiments, it will be appreciated that the wireless communication system 100 can connect to any type of UE, and the examples illustrated in FIG. 2 are not intended to limit the types of UEs that may be implemented within the system.

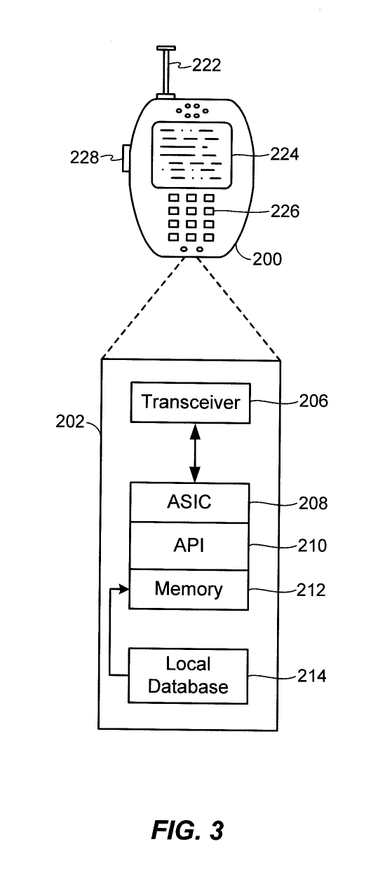

Referring to FIG. 3, a UE 200, (here a wireless device), such as a cellular telephone, has a platform 202 that can receive and execute software applications, data and/or commands transmitted from the RAN 120 that may ultimately come from the core network 126, the Internet 175 and/or other remote servers and networks. The platform 202 can include a transceiver 206 operably coupled to an application specific integrated circuit (“ASIC” 208), or other processor, microprocessor, logic circuit, or other data processing device. The ASIC 208 or other processor executes the application programming interface (“API’) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can hold applications not actively used in memory 212. The local database 214 is typically a flash memory cell, but can be any secondary storage device as known in the art, such as magnetic media, EEPROM, optical media, tape, soft or hard disk, or the like. The internal platform 202 components can also be operably coupled to external devices such as antenna 222, display 224, push-to-talk button 228 and keypad 226 among other components, as is known in the art.

Accordingly, an embodiment of the invention can include a UE including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the UE 200 in FIG. 3 are to be considered merely illustrative and the invention is not limited to the illustrated features or arrangement.

The wireless communication between the UE 102 or 200 and the RAN 120 can be based on different technologies or transport mechanisms, such as code division multiple access (CDMA), W-CDMA, time division multiple access (TDMA), frequency division multiple access (FDMA), Orthogonal Frequency Division Multiplexing (OFDM), the Global System for Mobile Communications (GSM), 3GPP Long Term Evolution (LTE) or other protocols that may be used in a wireless communications network or a data communications network. Accordingly, the illustrations provided herein are not intended to limit the embodiments of the invention and are merely to aid in the description of aspects of embodiments of the invention.

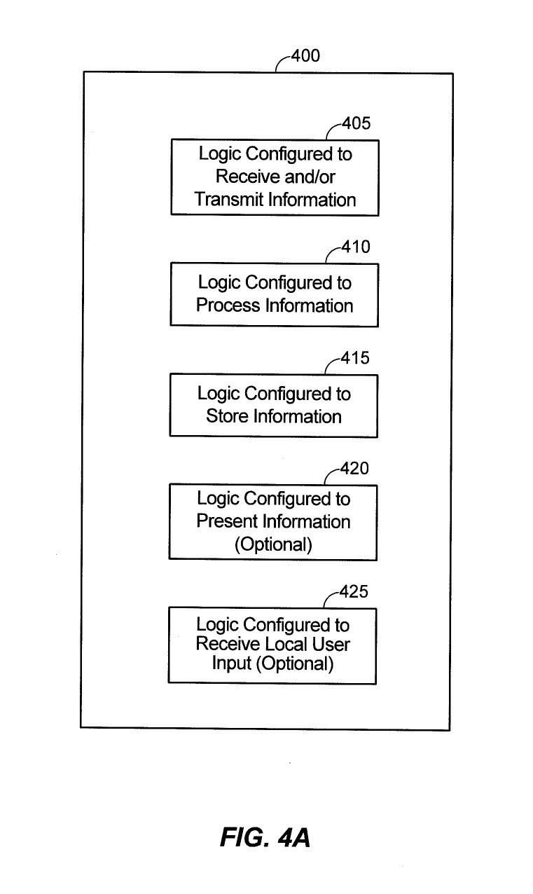

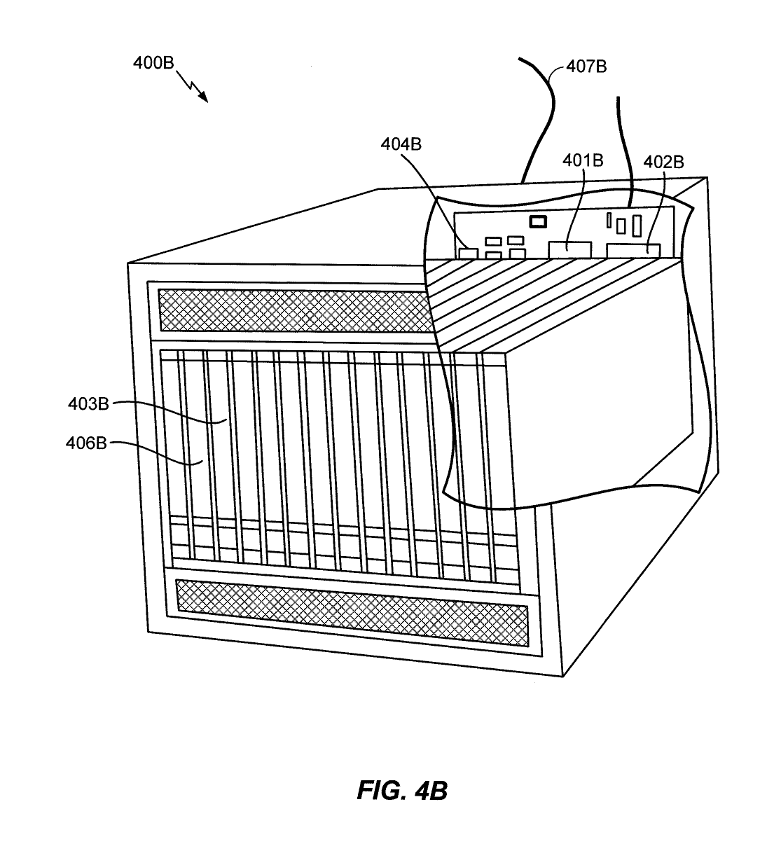

FIG. 4A illustrates a communication device 400 that includes logic configured to perform functionality. The communication device 400 can correspond to any of the above-noted communication devices, including but not limited to UEs 102, 108, 110, 112 or 200, Node Bs or base stations 120, the RNC or base station controller 122, a packet data network end-point (e.g., SGSN, GGSN, a Mobility Management Entity (MME) in Long Term Evolution (LTE), etc.), any of the servers 170 through 186, etc. Thus, communication device 400 can correspond to any electronic device that is configured to communicate with (or facilitate communication with) one or more other entities over a network.

Referring to FIG. 4A, the communication device 400 includes logic configured to receive and/or transmit information 405. In an example, if the communication device 400 corresponds to a wireless communications device (e.g., UE 200, Node B 124, etc.), the logic configured to receive and/or transmit information 405 can include a wireless communications interface (e.g., Bluetooth, WiFi, 2G, 3G, etc.) such as a wireless transceiver and associated hardware (e.g., an RF antenna, a MODEM, a modulator and/or demodulator, etc.). In another example, the logic configured to receive and/or transmit information 405 can correspond to a wired communications interface (e.g., a serial connection, a USB or Firewire connection, an Ethernet connection through which the Internet 175 can be accessed, etc.). Thus, if the communication device 400 corresponds to some type of network-based server (e.g., SGSN, GGSN, application server 170, etc.), the logic configured to receive and/or transmit information 405 can correspond to an Ethernet card, in an example, that connects the network-based server to other communication entities via an Ethernet protocol. In a further example, the logic configured to receive and/or transmit information 405 can include sensory or measurement hardware by which the communication device 400 can monitor its local environment (e.g., an accelerometer, a temperature sensor, a light sensor, an antenna for monitoring local RF signals, etc.). The logic configured to receive and/or transmit information 405 can also include software that, when executed, permits the associated hardware of the logic configured to receive and/or transmit information 405 to perform its reception and/or transmission function(s). However, the logic configured to receive and/or transmit information 405 does not correspond to software alone, and the logic configured to receive and/or transmit information 405 relies at least in part upon hardware to achieve its functionality.

Referring to FIG. 4A, the communication device 400 further includes logic configured to process information 410. In an example, the logic configured to process information 410 can include at least a processor. Example implementations of the type of processing that can be performed by the logic configured to process information 410 includes but is not limited to performing determinations, establishing connections, making selections between different information options, performing evaluations related to data, interacting with sensors coupled to the communication device 400 to perform measurement operations, converting information from one format to another (e.g., between different protocols such as .wmv to .avi, etc.), and so on. For example, the processor included in the logic configured to process information 410 can correspond to a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 410 can also include software that, when executed, permits the associated hardware of the logic configured to process information 410 to perform its processing function(s). However, the logic configured to process information 410 does not correspond to software alone, and the logic configured to process information 410 relies at least in part upon hardware to achieve its functionality.

Referring to FIG. 4A, the communication device 400 further includes logic configured to store information 415. In an example, the logic configured to store information 415 can include at least a non-transitory memory and associated hardware (e.g., a memory controller, etc.). For example, the non-transitory memory included in the logic configured to store information 415 can correspond to RAM memory, flash memory, ROM memory, EPROM memory, EEPROM memory, registers, hard disk, a removable disk, a CD-ROM, or any other form of storage medium known in the art. The logic configured to store information 415 can also include software that, when executed, permits the associated hardware of the logic configured to store information 415 to perform its storage function(s). However, the logic configured to store information 415 does not correspond to software alone, and the logic configured to store information 415 relies at least in part upon hardware to achieve its functionality.

Referring to FIG. 4A, the communication device 400 further optionally includes logic configured to present information 420. In an example, the logic configured to present information 420 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 400. For example, if the communication device 400 corresponds to UE 200 as shown in FIG. 3, the logic configured to present information 420 can include the display 224. In a further example, the logic configured to present information 420 can be omitted for certain communication devices, such as network communication devices that do not have a local user (e.g., network switches or routers, remote servers, etc.). The logic configured to present information 420 can also include software that, when executed, permits the associated hardware of the logic configured to present information 420 to perform its presentation function(s). However, the logic configured to present information 420 does not correspond to software alone, and the logic configured to present information 420 relies at least in part upon hardware to achieve its functionality.

Referring to FIG. 4A, the communication device 400 further optionally includes logic configured to receive local user input 425. In an example, the logic configured to receive local user input 425 can include at least a user input device and associated hardware. For example, the user input device can include buttons, a touch-screen display, a keyboard, a camera, an audio input device (e.g., a microphone or a port that can carry audio information such as a microphone jack, etc.), and/or any other device by which information can be received from a user or operator of the communication device 400. For example, if the communication device 400 corresponds to LIE 200 as shown in FIG. 3, the logic configured to receive local user input 425 can include the display 224 (if implemented a touch-screen), keypad 226, etc. In a further example, the logic configured to receive local user input 425 can be omitted for certain communication devices, such as network communication devices that do not have a local user (e.g., network switches or routers, remote servers, etc.). The logic configured to receive local user input 425 can also include software that, when executed, permits the associated hardware of the logic configured to receive local user input 425 to perform its input reception function(s). However, the logic configured to receive local user input 425 does not correspond to software alone, and the logic configured to receive local user input 425 relies at least in part upon hardware to achieve its functionality.

Referring to FIG. 4A, while the configured logics of 405 through 425 are shown as separate or distinct blocks in FIG. 4A, it will be appreciated that the hardware and/or software by which the respective configured logic performs its functionality can overlap in part. For example, any software used to facilitate the functionality of the configured logics of 405 through 425 can be stored in the non-transitory memory associated with the logic configured to store information 415, such that the configured logics of 405 through 425 each performs their functionality (i.e., in this case, software execution) based in part upon the operation of software stored by the logic configured to store information 415. Likewise, hardware that is directly associated with one of the configured logics can be borrowed or used by other configured logics from time to time. For example, the processor of the logic configured to process information 410 can format data into an appropriate format before being transmitted by the logic configured to receive and/or transmit information 405, such that the logic configured to receive and/or transmit information 405 performs its functionality (i.e., in this case, transmission of data) based in part upon the operation of hardware (i.e., the processor) associated with the logic configured to process information 410.

It will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the embodiments described below in more detail.

The various embodiments may be implemented on any of a variety of commercially available server devices, such as server 400B illustrated in FIG. 4B. In an example, the server 40013 may correspond to one example configuration of the application server 170 described above. In FIG. 4B, the server 400B includes a processor 401B coupled to volatile memory 402B and a large capacity nonvolatile memory, such as a disk drive 403B. The server 400B may also include a floppy disc drive, a writeable compact disc (CD) or writeable DVD disc drive 406B coupled to the processor 401B. The server 400B may also include network access ports 404B coupled to the processor 401 for establishing data connections with a network 407B, such as a local area network coupled to other broadcast system computers and servers or to the Internet. In context with FIG. 4A, it will be appreciated that the server 400B of FIG. 4B illustrates one example implementation of the communication device 400, whereby the logic configured to transmit and/or receive information 405 corresponds to the network access ports 404B used by the server 400B to communicate with the network 407B, the logic configured to process information 410 corresponds to the processor 401B, and the logic configuration to store information 415 corresponds to any combination of the volatile memory 402B, the disk drive 403B and/or the disc drive 406B. The optional logic configured to present information 420 and the optional logic configured to receive local user input 425 are not shown explicitly in FIG. 4B and may or may not be included therein. Thus, FIG. 4B helps to demonstrate that the communication device 400 may be implemented as a server, in addition to a UE implementation as in FIG. 3.

UEs can be configured to execute a number of different mobile applications that, when executed, are configured to interface with a number of external servers (e.g., the application servers 170, the web servers 186, etc.) via the RAN 120. For example, a mobile application for Facebook may be configured to contact a given application server 170 controlled by Facebook, a mobile web application may be configured to contact a number of different web servers 186 to retrieve web content, and so on.

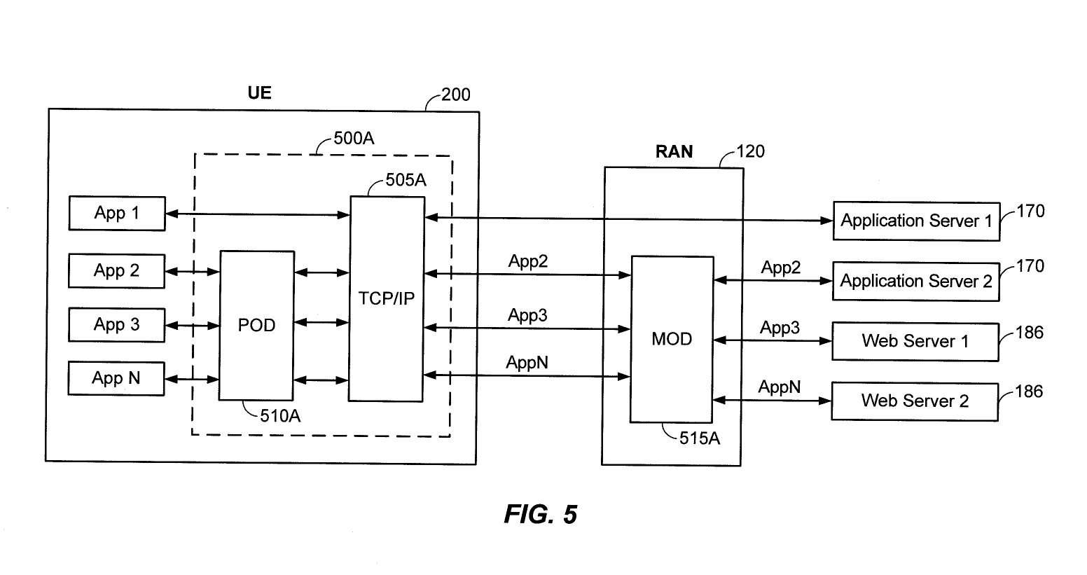

FIG. 5 illustrates a client-server architecture in accordance with an embodiment of the present invention. Referring to FIG. 5, UE 200 includes a plurality of mobile applications 1 . . . N and a transport layer 500A. The transport layer 500A is configured to convert data from mobile applications 1 . . . N into packets for transmission to the RAN 120. The transport layer 500A includes a conventional Transmission Control Protocol (TCP)/Internet Protocol (IP) layer or stack 505A, whereby the TCP/IP 505A is an example of a transport layer stack. As is known in the art, UE-originated data can be forwarded by any of the mobile applications 1 . . . N to the TCP/IP stack 505A (hereinafter referred to as TCP/IP 505A) and then converted into data packets which are queued for transmission to specified target servers (e.g., a Facebook server, a Netflix server, etc.) by the UE 200. Similarly, UE-terminated data that arrives from one or more external servers arrives at the TCP/IP 505A from which it can be disseminated to any of the mobile applications 1 . . . N. The transport layer 500A further includes a proxy on device (POD) 510A. The POD 510A is configured to interface with one or more of the mobile applications 1 . . . N and to execute a set of rules to determine whether data being exchanged between a particular mobile application and the TCP/IP 505A is permitted to be exchanged directly (i.e., without POD-enforced modifications), or whether the data will undergo a specialized handling procedure at the POD 510A. FIG. 5 illustrates an example whereby data for application 1 is permitted to be exchanged directly with the TCP/IP 505A (without POD involvement), and whereby data for applications 2 . . . N is first processed by the POD 510A. As will be described in greater detail below, the specialized handling procedure (or POD-MOD protocol) implemented by the POD 510A for UE-originated data can include data compression and also re-directing any data packet transmissions from the target server specified by the respective mobile application to a Mobile Optimized Data (MOD) server 515A, and the specialized handling procedure (or POD-MOD protocol) implemented by the POD 510A for UE-terminated data can include data decompression to undo compression that was implemented at the MOD 515A.

Further illustrated in FIG. 5 is the RAN 120. While the structural components (e.g., Node Bs, etc.) of the RAN 120 are not illustrated in FIG. 5 in detail, the RAN 120 is shown as including the MOD 51 5A. The MOD 51 SA can be implemented at different network locations of the RAN 120, including but not limited to a serving Node B of UE 200, an RNC, and so on. While not shown in FIG. 5, it is also possible that the MOD 515A could be moved outside of the RAN 120 so as to be implemented as an Internet destination within the Internet 175. As will be explained in greater detail below, the MOD 515A is responsible for interfacing with the POD 510A on UE 200. For UE-originated data, the MOD 515A receives the data packets from the POD 510A in a compressed format, which the MOD 515A can then decompress for transmission to the intended target server of the respective data packets. For UE-terminated data, the MOD 515A obtains data packets from an external source in a non-compressed format, the MOD 515A compresses the data packets, the MOD 515A then delivers the compressed data packets to UE 200 whereby the POD 510A can decompress the data for delivery to the intended target mobile application of the respective data packets. As used herein the compressed format can correspond to any modified data format that enhances or optimizes media payloads being exchanged between the POD 510A and the MOD 515A. Accordingly, from the perspective of both the individual mobile applications executing on UE 200 and the target servers that receive the data packets (either after the decompression by the MOD 515A or directly from TCP/IP 505A without POD or MOD involvement), the operations of the POD 510A and MOD 515A are logically or programmatically transparent. In other words, while the data payload itself is different via the specialized POD-MOD protocol (or compression), the end-to-end handling of the data payload can be the same despite the use of the MOD-POD protocol.

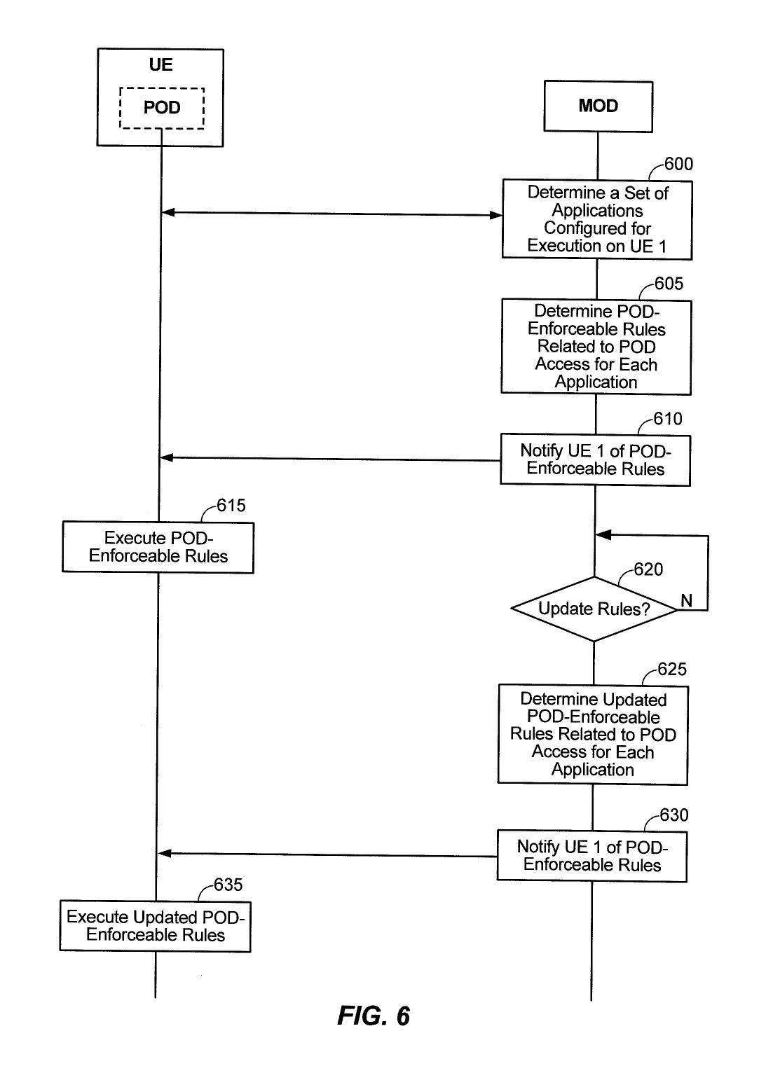

FIG. 6 illustrates an example of rule generation at the MOD 515A and distribution to the POD 510A in accordance with an embodiment of the invention. Referring to FIG. 6, the MOD 515A determines a set of applications (e.g., a mobile web browser, a YouTube client application, a Facebook client application, a Netflix client application, etc.) configured for execution on a given UE (denoted in FIG. 6 as UE 200), 600. The set of applications can correspond to applications that are currently installed on the given UE, or alternatively to any set of applications capable of being installed on the given UE so that, once installed, the POD 510A will be capable of executing rules for any of the set of applications. The set of applications may be identified explicitly (e.g., version X or a specific web browsing application), or alternatively may be defined by class or type. After determining the set of applications in 600, the MOD 515A determines a set of POD-enforceable rules related to POD access for each application in the set, 605. In other words, the MOD 515A generates rules that are client-executable at the given UE and are configured to facilitate the POD 510A to selectively apply POD-specific handling protocols or else divert to conventional handling protocols (e.g., based upon direct data exchanged between client applications and the TCP/IP 505A) for UE-originated data transmissions and/or UE-terminated data. In an example, the POD-enforceable rules can be device-specific based on the particular set of applications from 600 for the given UE, or can be standardized for execution on multiple UEs (e.g., UEs with similar applications executing thereon, or similar operating environments such as UEs that subscribe to 4G networks versus 3G networks, etc.).

Further, with respect to 605 of FIG. 6, one or more of the POD-enforceable rules determined at 605 can be based upon (i) a packet-state related to a type of data payload that a given application is attempting to transmit or receive, (ii) a device-state associated with UE 1 where the POD is installed, (iii) an application-state associated with the given application that is attempting to transmit or receive the data payload and/or (iv) a network-state associated with a serving network of UE 1. The POD-enforceable rules that are based on any of the aforementioned states can be user-specified (e.g., by a user of UE 1 in an example), developer-specified (e.g., by a developer of one or more of applications 1 . . . N), network-specified (e.g., by an operator of the serving network) or operator-specified (e.g., by an operator of the MOD 515A).

In an example of 605 of FIG. 6, a POD-enforceable rule based on the packet-state can instruct the POD 510A to apply the POD-specific handling protocols (e.g., intercepting data from delivery to/from the TCP/IP 505A) to data payloads of certain types while permitting data payloads of other types to be delivered to/from the TCP/IP 505A. For example, in context with UE-originated data, data payload types (e.g., image data payloads, audio data payloads, video data payloads, etc.) for which the POD 510A can apply a particular compression protocol (e.g., any protocol that converts the respective data payloads into a more efficient media format for delivery) can be intercepted by the POD 510A so that the compression protocol can be implemented for those data payload types, which can reduce an amount of over-the-air traffic transmitted by UE 1. In another example, in context with UE-terminated data, data payload types (e.g., image data payloads, audio data payloads, video data payloads, etc.) received at the POD 510A for which the MOD 515A has already applied the compression protocol (e.g., any protocol that converts the respective data payloads into a more efficient media format for delivery) can be intercepted by the POD 510A so that the compression protocol can be reversed (or decompressed) for those data payload types, which can reduce an amount of over-the-air traffic received by UE 1.

In another example of 605 of FIG. 6, a POD-enforceable rule based on the device-state can instruct the POD 510A to apply the POD-specific handling protocols (e.g., intercepting data from delivery to/from the TCP/IP 505A) to data payloads based on a status of UE 1. For example, the device-state can correspond to location, whereby the POD-enforceable rule can correspond to the POD 510A being instructed to apply the POD-specific handling protocols to data payloads when UE 1 is inside or outside of a defined location region (e.g., a region that is known to have high data congestion or small amounts of network infrastructure to handle data traffic, where compression via the POD-specific handling protocols can benefit the flow of media), and to otherwise permit data payloads to be delivered to/from the TCP/IP 505A without the POD-specific handling protocols if UE 1's relationship to the defined location region is not satisfied. For a location-based POD-enforceable rule, UE 1 can use any well-known position determination scheme (e.g., GPS, RF fingerprinting, forward trilateration, etc.) to determine its location and can then compare its determined location with the defined location region associated with the location-based POD-enforceable rule to determine whether the location-based POD enforceable rule is satisfied. Other examples of POD-enforceable rules based on device-state include instructing the POD 510A to apply the POD-specific handling protocols based on whether the associated UE is currently moving or has been stationary for a period of time, whether a camera on the associated UE detects a person looking at the camera (e.g., a user is looking at the screen of the UE and the user looking at the UE in this manner implies that the UE is waiting to access data so the POD-specific handling protocols can be used to expedite data delivery to the user) and the time of day or night (e.g., the POD-specific handling protocols can be used during the day during business hours where data demand is high, or at night if the user of the UE is known to be a night owl, etc.).

In another example of 605 of FIG. 6, a POD-enforceable rule can instruct the POD 510A to apply the POD-specific handling protocols (e.g., intercepting data from delivery to/from the TCP/IP 505A) to data payloads based on an application state associated with the application that is attempting to transmit a data payload via the TCP/IP 505A. For example, the POD-enforceable rule can identify a set of applications (or application types) for which the POD 510A is instructed to apply the POD-specific handling protocols (e.g., intercepting data from delivery to/from the TCP/IP 505A) to data payloads originating from (or targeted to) the identified set of applications, while permitting data payloads originating from (or targeted to) other applications (or application types) to be delivered to/from the TCP/IP 505A without POD-intervention. In another example, the POD-enforceable rule can specify foreground or background execution as a trigger for which the POD 510A is instructed to apply the POD-specific handling protocols (e.g., intercepting data from delivery to/from the TCP/IP 505A), while permitting data payloads originating from (or targeted to) other applications that are executing in a different mode to be delivered to/from the TCP/IP 505A without POD-intervention.

In another example of 605 of FIG. 6, a POD-enforceable rule can instruct the POD 510A to apply the POD-specific handling protocols (e.g., intercepting data from delivery to/from the TCP/IP 505A) to data payloads based on a network state associated with a serving network of UE 1 when a given application on UE 1 is attempting to transmit or receive a data payload via the TCP/IP 505A. For example, the POD-enforceable rule can identify particular types of serving networks (e.g., 3G, 4G, WiFi, etc.) for which, when UE 1 is connected thereto, the POD 510A is instructed to apply the POD-specific handling protocols (e.g., intercepting data from delivery to the TCP/IP 505A) to data payloads, while permitting data payloads to be delivered to/from the TCP/IP 505A when the UE is not connected thereto. In another example, the POD-enforceable rule can evaluate network data costs and/or network data limits associated with UE 1. In this case, if UE 1 is connected to a serving network that is particularly expensive or to which UE 1 has already exceeded a monthly data maximum associated with a network service subscription, the POD 510A is instructed to apply the POD-specific handling protocols (e.g., intercepting data from delivery to/from the TCP/IP 505A) to data payloads, while permitting data payloads to be delivered to/from the TCP/IP 505A when the UE is not connected to such restrictive networks thereto.

As will be appreciated, POD-enforceable rules can be based upon packet-state, device-state, application-state or network-state either individually or in any combination with each other. Thus, a first POD-enforceable rule can be based upon packet-state in conjunction with application-state (e.g., apply POD-specific handling protocols for specific data payload types transmitted from specific application types), a second POD-enforceable rule can be based upon device-state in conjunction with network-state (e.g., apply POD-specific handling protocols for UEs in particular location regions while the UEs are connected to specified network types) and so on. Also, for UE-terminated data, the POD-enforceable rules can be used in conjunction with MOD operation. For example, a POD-enforceable rule for the POD 510A to decompress UE-terminated data packets is based in part upon the MOD 515A compressing those data packets in the first place.

In another embodiment of 605, the POD-enforceable rules determined at 605 can be crowd sourced from one or more other UEs. For example, assume that the MOD 515A determines that UE 1 is executing applications 1, 2 and 3 at 600. The MOD 515A can use the identification of the applications 1, 2 and 3 to leverage information associated with their respective execution at other UEs to populate the POD-enforceable rules at 605. In an example for a POD-enforceable rule based on application-state, if application 1 has a history of experiencing errors in execution when serviced by PODs 510A at other UEs, a POD-enforceable rule for application 1 may be to bypass the POD 510A in favor of a direct transfer to/from the TCP/IP 505A. In an example for a POD-enforceable rule based on network-state, if application 2 has a history of experiencing errors in execution when serviced by PODs 510A at other UEs over 3G networks and a history of acceptable performance in execution when serviced by PODs 510A at other UEs over 4G networks, the POD-enforceable rule for application 2 may be to invoke the POD 510A for servicing application 2's data when 4G-connected and to bypass the POD 510A in favor of direct transfers to/from the TCP/IP 505A for application 2's data when 3G-connected. Accordingly, knowledge related to the execution of UE 1's applications from other UEs in the “crowd” can be used to generate the POD-enforceable rules delivered to the given UE at 605.

After generating the POD-enforceable rules, the MOD 515A notifies the given UE of the POD-enforceable rules, 610, and the POD 510A on the given UE installs and executes the POD-enforceable rules, 615. The POD-enforceable rules for the given UE need not be static, such that the MOD 515A can determine, on a periodic or event-driven basis, whether to update the POD-enforceable rules, 620. For example, if the MOD 515A becomes aware of a new application executing on the given UE, the POD-enforceable rules may be determined to be updated at 620 so that the POD 510A on the given UE will know how to handle data transmission attempts and/or data reception by the new application. If the MOD 515A determines to update the POD-enforceable rules for the given UE in 620, the MOD 515A determines an updated set of POD-enforceable rules, 625, the MOD 515A notifies the given UE of the updated POD-enforceable rules, 630, and the POD 510A on the given UE installs and executes the updated. POD-enforceable rules, 635.

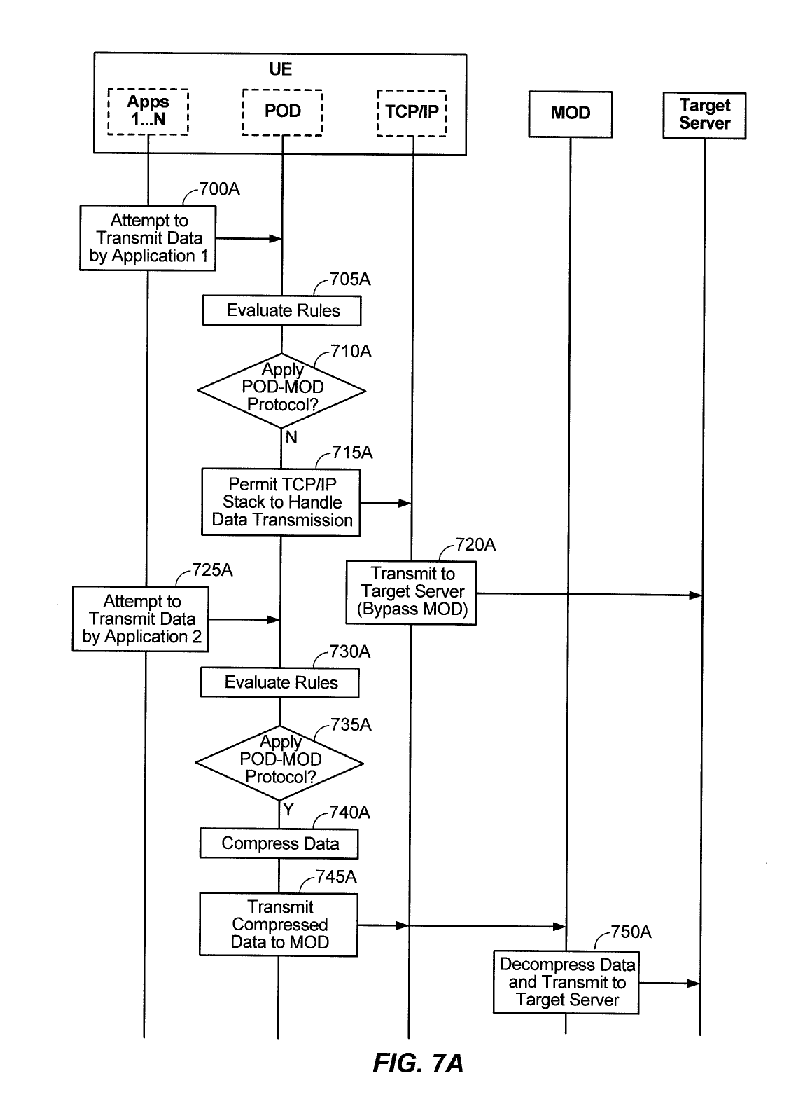

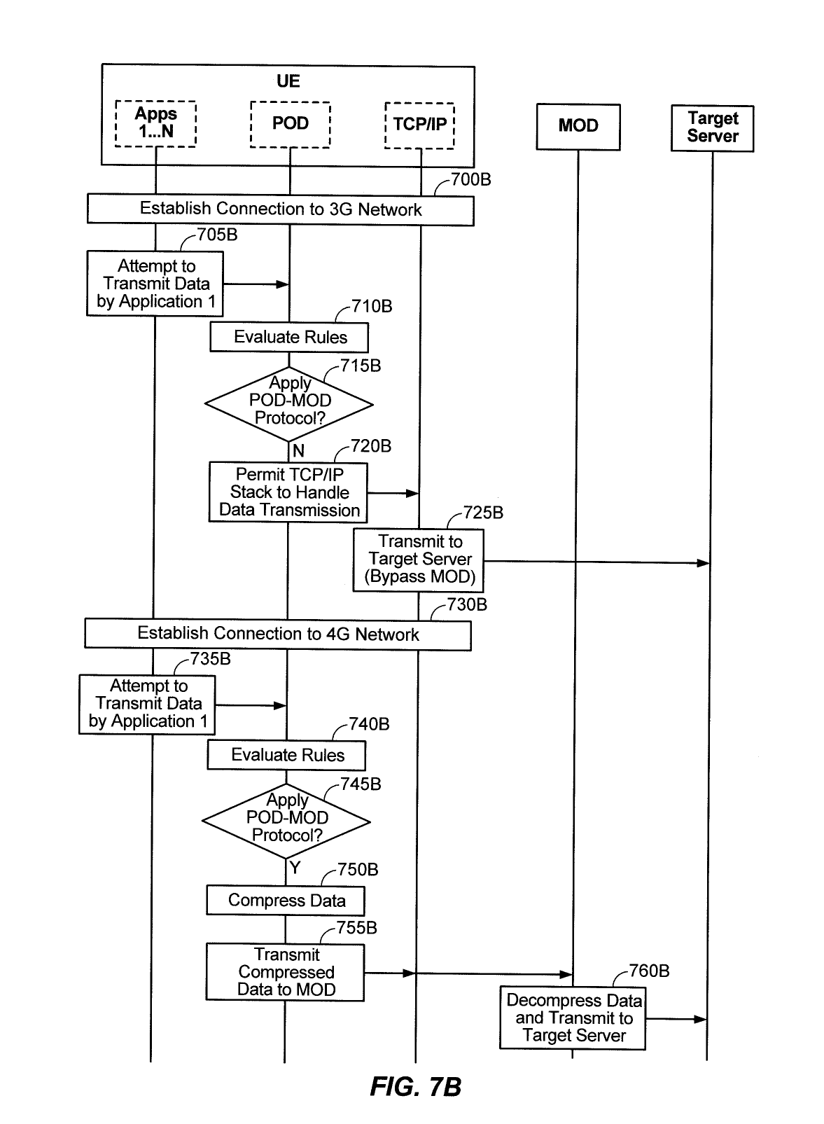

FIG. 7A illustrates an example execution of the POD-enforceable rules at the given UE in accordance with an embodiment of the present invention. For example, FIG. 7A constitutes an example of 615 and/or 635 from FIG. 6 in context with an upload (or UE-originated) scenario.

Referring to FIG. 7A, assume that the process of FIG. 6 has executed insofar that the POD 510A on the given UE is provisioned with a set of POD-enforceable rules governing POD access for data transmission attempts by applications 1 . . . N. In particular, assume that the POD-enforceable rules include a first rule that permits a first application (“application 1”) to bypass the POD 510A such that data from application 1 for transmission to a target server is directed to the TCP/IP 505A instead of the POD 510A, and a second rule whereby data from a second application (“application 2”) is intercepted by the POD 510A such that the data from application 2 for transmission to the target server is handled by the POD 510A prior to delivery to the TCP/IP 505A. This example set of rules is illustrated in the data flow shown in the client-server architecture diagram of FIG. 5.

With these assumptions in mind, the POD 510A detects that application 1 is attempting to transmit data to a given target server, 700A. For example, application 1 may be a mobile web browsing application that is attempting to transmit a request to load a web page from one of the web servers 186, or application 1 may be a multimedia application attempting to transmit a call set-up message to initiate a group communication session arbitrated by one of the application servers 170, and so on. The POD 510A evaluates the POD-enforceable rules, 705A, and based on the evaluation from 705A, the POD 510A determines not to apply a specialized handling procedure (or POD-MOD protocol) to application 1's data transmission attempt, 710A (e.g., because the first rule instructs the POD 510A to bypass the POD-MOD protocol for application 1). For example, application 1 may be blacklisted from the POD-MOD protocol for any of a variety of reasons, such as application 1 being known to provide data that cannot be further compressed by the POD-MOD protocol, a history of failures associated with processing requests from application 1 through the POD-MOD protocol, and so on. In another example, the MOD 515A may be overloaded or otherwise incapable of servicing the transmission from the POD 510A which prompts the POD 510A to determine not to apply the POD-MOD protocol at 710A (e.g., the MOD 515A may notify the POD 510A with respect to its current ability to handle data requests, and this notification may prompt invocation of this rule). Accordingly, in the embodiment of FIG. 7A, the POD 510A determines not to apply the POD-MOD protocol in 710A, and thereby the POD 510A permits the data transmission attempt to be fielded by the TCP/IP 505A without any POD-intervention, 715A. The TCP/IP 505A thereby transmits application 1's data to the given target server without traversing the MOD 515A, 720A.

Referring to FIG. 7A, at 725A, the POD 510A next detects that application 2 is attempting to transmit data to a given target server, 725A. The POD 510A evaluates the POD-enforceable rules, 730A, and based on the evaluation from 730A, the POD 510A determines to apply a specialized handling procedure (or POD-MOD protocol) to application 2's data transmission attempt, 735A (e.g., because the second rule instructs the POD 510A to invoke the POD-MOD protocol for application 2). For example, unlike application 1, application 2 may be whitelisted (or included) within the POD-MOD protocol for any of a variety of reasons, such as application 2 being known to provide data that can be further compressed by the POD-MOD protocol, a history of successes associated with processing requests from application 2 through the POD-MOD protocol, and so on. Accordingly, to apply the POD-MOD protocol to application 2's data transmission attempt, the POD 510A compresses application 2's data in accordance with a given compression technique, 740A. For example, the given compression technique can include “zipping” of text payloads and header fields, and/or reducing a quality of payload media (e.g., by image cropping a payload portion that corresponds to image data, reducing a resolution of image, video and/or audio payload data, etc.). The compression of application 2's data at 740A results in a conversion of application 2's data into a format that can be transmitted in a more compact manner for over-the-air (OTA) transmission by the given UE. After compressing application 2's data in accordance with the given compression technique in 740A, the POD 510A delivers the compressed data to the TCP/IP 505A for transmission within one or more data packets to the MOD 515A instead of the given target server, 745A. In an example, the POD-to-MOD transmission of 745A can be enhanced somewhat based on a mutual understanding of the POD and MOD capabilities. For example, if application 2's data for transmission includes text-based responses, the text-based responses can be sent over http with an http header portion that include an accept-encoding:gzip field within the http header portion in 745A. This is based on an assumption that the POD 510A and MOD 515A can recognize the accept-encoding:gzip field, which cannot always be assumed where the respective capabilities of the source and destination are unknown. The MOD 515A receives the compressed data (e.g., within a payload portion) within the one or more data packets and then decompresses the compressed data to produce uncompressed data (i.e., the data originally requested for transmission by application 2 at the given UE prior to the POD-implemented compression) and transmits the uncompressed data to the given target server, 750A.

FIG. 7B illustrates another example execution of the POD-enforceable rules at the given UE in accordance with an embodiment of the present invention. For example, FIG. 7B constitutes another example of 615 and/or 635 from FIG. 6 in context with an upload. (or UE-originated) scenario. While FIG. 7A illustrates an example of invoking or bypassing the POD-MOD protocol for data transmission handling based on application identification, FIG. 7B illustrates an example whereby a current network connection type (e.g., 3G or 4G) is used as a secondary factor of the POD-enforceable rules.

Referring to FIG. 7B, assume that the process of FIG. 6 has executed insofar that the POD 510A on the given UE is provisioned with a set of POD-enforceable rules governing POD access for data transmission attempts by applications 1 . . . N. In particular, assume that the POD-enforceable rules include a first rule that permits a first application (“application 1”) to bypass the POD 510A if connected to a 3G network such that data from application 1 for transmission to a target server is directed to the TCP/IP 505A instead of the POD 510A, and a second rule whereby data from application 1 is intercepted by the POD 510A if the given UE is connected to a 4G network such that the data from application 1 for transmission to the target server is handled by the POD 510A prior to being delivered to the TCP/IP 505A for transmission.

With these assumptions in mind, the given UE establishes a connection to a 3G network, 700B. While connected to the 3G network, the POD 510A detects that application 1 is attempting to transmit data to a given target server, 705B. For example, application 1 may be a mobile web browsing application that is attempting to transmit a request to load a web page from one of the web servers 186, or application 1 may be a multimedia application attempting to transmit a call set-up message to initiate a group communication session arbitrated by one of the application servers 170, and so on. The POD 510A evaluates the POD-enforceable rules, 710B, and based on the evaluation from 710B, the POD 510A determines not to apply a specialized handling procedure (or POD-MOD protocol) to application 1's data transmission attempt, 715B (e.g., because the first rule instructs protocol while 3G-connected for any of a variety of reasons, such as application 1 being known to provide data that cannot be further compressed by the POD-MOD protocol over 3G networks, a history of failures associated with processing requests from application 1 through the POD-MOD protocol in 3G networks, and so on). Accordingly, in the embodiment of FIG. 7B, the POD 510A determines not to apply the POD-MOD protocol in 715B, and thereby the POD 510A permits the data transmission attempt to be fielded by the TCP/IP 505A without POD-intervention, 720B. The TCP/IP 505A thereby transmits application 1's data to the given target server without traversing the MOD 515A, 725B.

Referring to FIG, 7B, at 730B, the given UE establishes a connection to a 4G network. While connected to the 4G network, the POD 510A next detects that application 1 is attempting to transmit data to the given target server, 735B. The POD 510A evaluates the POD-enforceable rules, 740B, and based on the evaluation from 740B, the POD 510A determines to apply a specialized handling procedure (or POD-MOD protocol) to application 1's data transmission attempt, 745B (e.g., because the second rule instructs the POD 510A to invoke the POD-MOD protocol for application 1 when the given UE is connected to the 40 network). For example, unlike 3G networks, application 1 for 3G-connected UEs may be whitelisted (or included) within the POD-MOD protocol for any of a variety of reasons, such as application 1 being known to provide data that can be further compressed by the POD-MOD protocol within 4G networks, a history of successes associated with processing requests from application 1 through the POD-MOD protocol in 4G networks, and so on. Next, except for being implemented with respect to application 1's data instead of application 2's data as in FIG. 7A, 750B through 760B substantially correspond to 740A through 750A from FIG. 7A, and as such will not be described further for the sake of brevity.

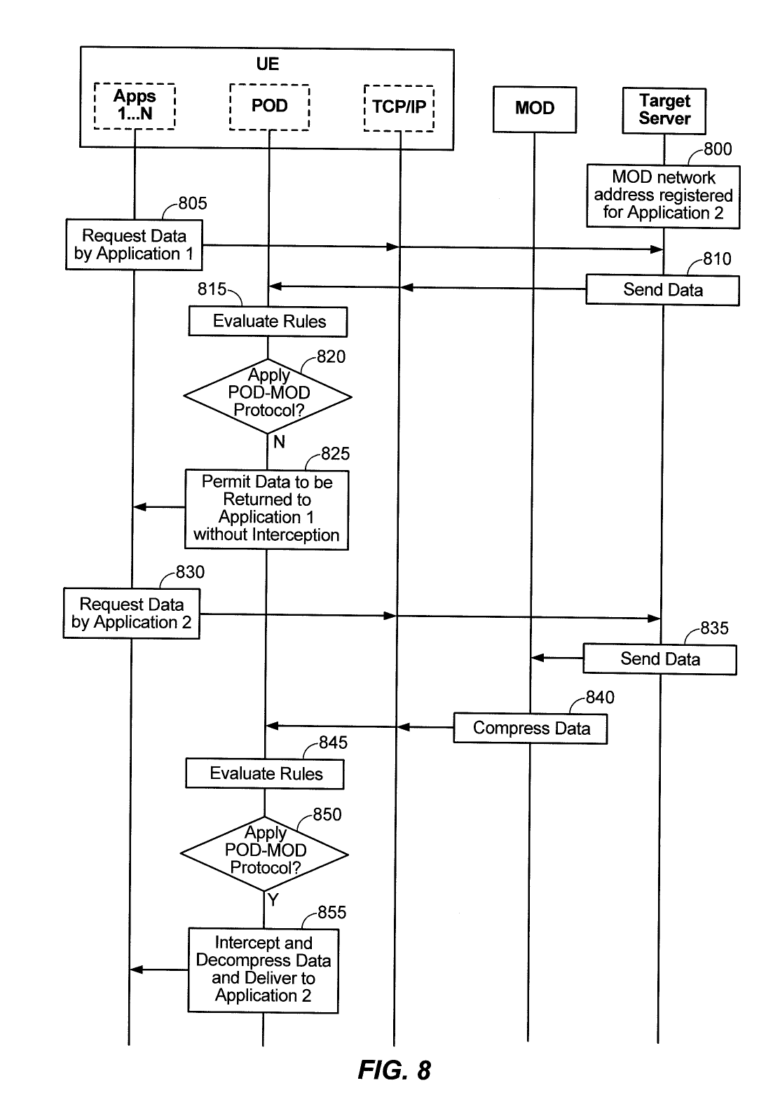

While the above-described embodiments are primarily described with respect to UE-originated transmissions from the POD 510A to the MOD 515A, other embodiments can be directed to 11E-terminated transmissions (or pull traffic), as will be described below with respect to FIG. 8. FIG. 8 illustrates an example execution of the POD-enforceable rules at the given UE in accordance with another embodiment of the present invention. For example, FIG. 8 constitutes an example of 615 and/or 635 from FIG. 6 in context with a download (or UE-terminated) scenario.

Referring to FIG. 8, assume that the process of FIG. 6 has executed insofar that the POD 510A on the given UE is provisioned with a set of POD-enforceable rules governing POD access for UE-terminated data configured to be delivered to applications 1 . . . N. In particular, assume that the POD-enforceable rules include a first rule that permits a first application (“application 1”) to bypass the POD 510A such that data being delivered from a target server for application 1 is transferred from the TCP/IP 505A to application 1 without special handling by the POD 510A, and a second rule whereby data from the target server for a second application (“application 2”) is intercepted by the POD 510A such that the data for application 2 is processed by the POD 510A instead of being delivered directly to application 2 from the TCP/IP 505A. This example set of rules is illustrated in the data flow shown in the client-server architecture diagram of FIG. 5.

With these assumptions in mind, assume that a network address for the MOD 515A is registered in association with application 2 on UE 1, 800. In other words, the target server is configured to deliver data that is targeted to application 2 on UE 1 by delivering the data to the MOD 515A instead of sending the data directly to UE 1. In an example, the network address of the MOD 515A can be registered with the target server in conjunction with execution of FIG. 6 for example, such as during 630 of FIG. 6, whereby the target server can be provisioned with the network address of the MOD 515A in conjunction with the POD 510A being notified of the POD-enforceable rules that instruct the POD-MOD protocol to be implemented for data that arrives at UE 2 for application 2.

Referring to FIG. 8, application 1 transmits a request for data to a given target server, 805. For example, application 1 may be a mobile web browsing application that is attempting to request a web page from one of the web servers 186, or application 1 may be a multimedia application attempting to request set-up of a group communication session arbitrated by one of the application servers 170, and so on. The given target server receives the request from 805 and provides the requested data to the TCP/IP 505A on UE 1, 810. At this point, the POD 510A evaluates the POD-enforceable rules, 815, and based on the evaluation from 815, the POD 510A determines not to apply a specialized handling procedure (or POD-MOD protocol) to application 1's data, 820 (e.g., because the first rule instructs the POD 510A to bypass the POD-MOD protocol for application 1). For example, application 1 may be blacklisted from the POD-MOD protocol for any of a variety of reasons, such as application 1 being known to receive data that cannot be decompressed by the POD-MOD protocol, a history of failures associated with processing data targeted to application 1 through the POD-MOD protocol, and so on. In another example, the POD 510A can detect that the data for application I was not compressed by the MOD 515A, such that no decompression of application 1's data is necessary, which in turn prompts the POD 510A to determine not to apply the POD-MOD protocol at 820 (e.g., the MOD 515A may flag packets with data payloads that have been compressed so the POD 510A can figure out which packets to intercept for special handling, or the POD 510A may compare a requested data format from 805 with a received data format at 810, with the ‘flag’ being whether the request data format equals the received data format). Accordingly, in the embodiment of FIG. 8, the POD 510A determines not to apply the POD-MOD protocol in 820, and thereby the POD 510A permits the data for application 1 to be delivered to application 1 from the TCP/IP 505A without POD-intervention, 825.

Referring to FIG. 8, application 2 transmits a request for data to the given target server, 830. For example, application 2 may be a mobile web browsing application that is attempting to request a large image file, etc. The given target server receives the request from 830 and associates the request as being for application 2 for which the network address of the MOD 515A is registered at 800. Thereby, at 835, the given target server provides the requested data to the MOD 515A instead of sending the requested data directly to UE 1 as at 810. The MOD 515A receives the data from the given target server, determines that the data includes a data payload that is capable of compression, compresses the data payload in accordance with a given compression technique, and then delivers the compressed data to the TCP/IP 505A on UE 1, 840. For example, the data received by the MOD 515A at 835 can correspond to an image in a .jpg (or JPEG) format, and the MOD 515A can convert the image into a .webp format at 840. In another example, the given compression technique can include “zipping” of text payloads and header fields, and/or reducing a quality of payload media (e.g., by image cropping a payload portion that corresponds to image data, reducing a resolution of image, video and/or audio payload data, etc.). The compression of application 2's data at 840 results in a conversion of application 2's data into a format that can be transmitted in a more compact manner for over-the-air (OTA) transmission to UE 1. In a further example, the MOD 515A can flag the data transmitted to UE 1 at 840 as being compressed to trigger intervention by the POD 510A.

After the compressed data is received at the TCP/IP 505A on UE 1, the POD 510A evaluates the POD-enforceable rules, 845, and based on the evaluation from 845, the POD 510A determines to apply a specialized handling procedure (or POD-MOD protocol) to application 2's data, 850 (e.g., because the second rule instructs the POD 510A to invoke the POD-MOD protocol for application 2). For example, unlike application 1, application 2 may be whitelisted (or included) within the POD-MOD protocol for any of a variety of reasons, such as application 2 being known to provide data that can be further compressed by the POD-MOD protocol, a history of successes associated with processing requests from application 2 through the POD-MOD protocol, and so on. Alternatively, the POD 510A can identify that the data received at 840 was compressed by the MOD 515A and thereby requires decompression before delivery to application 2. For example, if the data corresponds to an image file that the MOD 515A converted from .jpg (or JPEG) format to a .webp format at 840, the POD 510A can detect that the received data format (i.e., .webp) is different than the requested data format from 830 (i.e., .jpg), so that the .webp tile needs to be converted into .webp prior to delivery to application 2. The POD 510A thereby intercepts the compressed data from the TCP/IP 505A and decompresses the compressed data using the POD-MOD protocol, after which the decompressed data is delivered to application 2, 855.

Further, while the above-described embodiments are primarily described with respect to wireless communication networks, the embodiments can also be implemented via wired networks as well. Also, while the above-described embodiments are primarily described with respect to TCP/IP as an exemplary transport layer stack, it will be appreciated that other embodiments of the invention can be directed towards any type of transport layer stack and not necessarily TCP/IP.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of operating a management application that is configured for execution on a user equipment (UE), comprising:
obtaining, from a proxy server, a set of rules for selectively intercepting data from being delivered from a set of applications to a transport layer stack on the UE:
detecting that a first application in the set of applications is attempting to deliver a first data payload to the transport layer stack on the UE for transmission to a first target server;
determining to intercept the delivery of the first data payload from the first application to the transport layer stack based on one or more rules from the set of rules being satisfied for the first data payload, wherein the one or more rules instruct the management application to intercept delivery of data payloads to the transport layer stack based on (i) a packet-state related to a type of the first data payload, (ii) a device-state associated with the UE, (iii) an application-state associated with the first application and/or (iv) a network-state associated with a serving network of the UE; and
in response to the intercept determination for the first data payload, intercepting the delivery of the first data payload from the first application to the transport layer stack, modifying the intercepted first data payload to conform to a protocol used for communications between the management application and the proxy server, and transmitting the modified intercepted first data payload to the proxy server.

2. The method of claim 1, wherein the transport layer stack corresponds to a Transmission Control Protocol (TCP)/Internet Protocol (IP) stack.

3. The method of claim 1, wherein the one or more rules instruct the management application to intercept delivery of data payloads to the transport layer stack based on the packet-state.

4. The method of claim 3, wherein the one or more rules instruct the management application to intercept delivery of data payloads to the transport layer stack that correspond to one or more of a set of data payload types for which the management application is configured to apply a payload type-specific compression protocol that is different from data formatting that is applied by the transport layer stack.

5. The method of claim 4, wherein the set of data payload types includes image data payloads, audio data payloads and/or video data payloads.

6. The method of claim 1, wherein the one or more rules instruct the management application to intercept delivery of data payloads to the transport layer stack based on the device-state.

7. The method of claim 6, wherein the one or more rules instruct the management application to intercept delivery of data payloads to the transport layer stack based on a location of the UE.

8. The method of claim 7, wherein the one or more rules define a location region whereby the management application is instructed to intercept delivery of data payloads to the transport layer stack when the UE is inside the location region and the management application is instructed not to intercept delivery of data payloads to the transport layer stack when the UE is not inside the location region.

9. The method of claim 7, wherein the one or more rules define a location region whereby the management application is instructed to intercept delivery of data payloads to the transport layer stack when the UE is outside the location region and the management application is instructed not to intercept delivery of data payloads to the transport layer stack when the UE is not outside the location region.

10. The method of claim 1, wherein the one or more rules instruct the management application to intercept delivery of data payloads to the transport layer stack based on the application-state.

11. The method of claim 10, wherein the one or more rules instruct the management application to intercept delivery of data payloads to the transport layer stack that originate from a specified set of applications including the first application.

12. The method of claim 1, wherein the one or more rules instruct the management application to intercept delivery of data payloads to the transport layer stack based on the network-state.

13. The method of claim 12, wherein the one or more rules instruct the management application to intercept delivery of data payloads to the transport layer stack based on a performance or type of the serving network.

14. The method of claim 13, wherein the one or more rules instruct the management application to intercept delivery of data payloads to the transport layer stack when the performance of the serving network is below or above a threshold.

15. The method of claim 13,
wherein the one or more rules instruct the management application to intercept delivery of data payloads to the transport layer stack when the UE is connected to serving networks of a first type, and
wherein the one or more rules instruct the management application not to intercept delivery of data payloads to the transport layer stack when the UE is connected to serving networks of a second type.

16. The method of claim 15, wherein the first type includes cellular networks.

17. The method of claim 15, wherein the second type includes WiFi networks.

18. The method of claim 12, wherein the one or more rules instruct the management application to intercept delivery of data payloads to the transport layer stack based on a subscription status of the UE with the serving network.

19. The method of claim 12, wherein the one or more rules instruct the management application to intercept delivery of data payloads to the transport layer stack based on data usage costs to be charged for the UE for accessing the serving network.

20. The method of claim 1, wherein the modifying step includes:
compressing the first data payload based on a given compression protocol that is different from data formatting that is applied by the transport layer stack.

21. The method of claim 1, further comprising:
detecting an attempt to deliver a second data payload to the transport layer stack on the UE for transmission to a second target server;
determining, by the management application, not to intercept the delivery of the second data payload to the transport layer stack based on a failure of one or more rules from the set of rules to be satisfied for the second data payload; and
in response to the no intercept determination for the second data payload, permitting delivery of the second data payload to the transport layer stack for transmission to the second target server without intercepting the second data payload for modification by the management application.

22. A method of operating a proxy server, comprising:
determining a set of applications configured for execution on a user equipment (UE);
determining a set of rules to be enforced by a management application on the UE, wherein each rule in the set of rules is configured to manage whether to intercept data between the set of applications and a transport layer stack for data payload modification, wherein the set of rules includes one or more rules that instruct the management application to selectively intercept the data based on (i) a packet-state related to a data payload of the data (ii) a device-state associated with the UE, (iii) an application-state associated with an application from which the data originates or to which the data is targeted and/or (iv) a network-state associated with a serving network of the UE; and
delivering the set of rules to the UE for enforcement by the management application.

23. The method of claim 22, further comprising:
receiving, from the UE based on the set of rules, a given data payload that is intercepted by the management application, modified to conform to a protocol used for communications between the management application and the proxy server and redirected to the proxy server;
reversing the modification applied to the given data payload to conform to the protocol in order to produce an unmodified version of the given data payload; and
transmitting the unmodified version of the given data payload to a target server for the given data payload that was specified by a given application from the set of applications on the UE prior to the given data payload being intercepted by the management application based on the set of rules.

24. The method of claim 23,
wherein the given data payload is modified to conform to the protocol by compressing the given data payload based on a given compression protocol that is different from data formatting that is applied by the transport layer stack on the UE, and
wherein the reversing of the modification decompresses the compressed given data payload.

25. The method of claim 22, wherein the one or more rules instruct the management application to intercept delivery of data payloads based on the packet-state.

26. The method of claim 25, wherein the one or more rules instruct the management application to intercept delivery of data payloads between the set of applications and the transport layer stack that correspond to one or more of a set of data payload types for which the management application is configured to apply a payload type-specific compression protocol that is different from data formatting that is applied by the transport layer stack.

27. The method of claim 26, wherein the set of data payload types includes image data payloads, audio data payloads and/or video data payloads.

28. The method of claim 22, wherein the one or more rules instruct the management application to intercept delivery of data payloads between the set of applications and the transport layer stack based on the device-state.

29. The method of claim 28, wherein the one or more rules instruct the management application to intercept delivery of data payloads between the set of applications and the transport layer stack based on a location of the UE.

30. The method of claim 29, wherein the one or more rules define a location region whereby the management application is instructed to intercept delivery of data payloads between the set of applications and the transport layer stack when the UE is inside the location region and the management application is instructed not to intercept delivery of data payloads between the set of applications and the transport layer stack when the UE is not inside the location region.

31. The method of claim 29, wherein the one or more rules define a location region whereby the management application is instructed to intercept delivery of data payloads between the set of applications and the transport layer stack when the UE is outside the location region and the management application is instructed not to intercept delivery of data payloads between the set of applications and the transport layer stack when the UE is not outside the location region.

32. The method of claim 22, wherein the one or more rules instruct the management application to intercept delivery of data payloads between the set of applications and the transport layer stack based on the application-state.

33. The method of claim 32, wherein the one or more rules instruct the management application to intercept delivery of data payloads between the set of applications and the transport layer stack that originate from a specified set of applications.

34. The method of claim 32, wherein the one or more rules instruct the management application to intercept delivery of data payloads between the set of applications and the transport layer stack based on whether the data payloads originate from or are targeted to an application that is operating in a foreground or a background of the UE.

35. The method of claim 22, wherein the one or more rules instruct the management application to intercept delivery of data payloads to the transport layer stack based on the network-state.

36. The method of claim 35, wherein the one or more rules instruct the management application to intercept delivery of data payloads between the set of applications and the transport layer stack based on a performance or type of the serving network.

37. The method of claim 36, wherein the one or more rules instruct the management application to intercept delivery of data payloads between the set of applications and the transport layer stack when the performance of the serving network is below or above a threshold.

38. The method of claim 36,
wherein the one or more rules instruct the management application to intercept delivery of data payloads between the set of applications and the transport layer stack when the UE is connected to serving networks of a first type, and
wherein the one or more rules instruct the management application not to intercept delivery of data payloads between the set of applications and the transport layer stack when the UE is connected to serving networks of a second type.

39. The method of claim 38, wherein the first type includes cellular networks.

40. The method of claim 38, wherein the second type includes WiFi networks,

41. The method of claim 35, wherein the one or more rules instruct the management application to intercept delivery of data payloads between the set of applications and the transport layer stack based on a subscription status of the UE with the serving network.

42. The method of claim 35, wherein the one or more rules instruct the management application to intercept delivery of data payloads between the set of applications and the transport layer stack based on data usage costs to be charged for the UE for accessing the serving network.

43. The method of claim 22, wherein the transport layer stack corresponds to a Transmission Control Protocol (TCP)/Internet Protocol (IP) stack.

44. The method of claim 22, further comprising:
obtaining, for delivery to a target application on the UE, a given data payload;
modifying the given data payload to conform to a protocol used for communications between the management application and the proxy server;
transmitting the modified version of the given data payload to the UE,
wherein, based on the set of rules, the UE is expected to intercept the modified version of the given data payload between the transport layer stack and the target application in order to reverse the modification applied to the given data payload.

45. The method of claim 44,
wherein the given data payload is modified to conform to the protocol by compressing the given data payload based on a given compression protocol.

46. A method of operating a management application that is configured for execution on a user equipment (UE), comprising:
obtaining, from a proxy server, a set of rules for selectively intercepting data from being delivered from a transport layer stack on the UE to a set of applications on the UE;
detecting a first data payload on the transport layer stack that is configured for delivery to a first application in the set of applications, wherein the first data payload is a compressed version of a data payload that originated from a target server;
determining to intercept the delivery of the first data payload from the transport layer stack to the first application based on one or more rules from the set of rules being satisfied for the first data payload, wherein the one or more rules instruct the management application to intercept delivery of data payloads from the transport layer stack based on (i) a packet-state related to a type of the first data payload, (ii) a device-state associated with the UE, (iii) an application-state associated with the first application and/or (iv) a network-state associated with a serving network of the UE; and
in response to the intercept determination for the first data payload, intercepting the first data payload from delivery from the transport layer stack to the first application, decompressing the intercepted first data payload to produce the data payload that originated from the target server and delivering the decompressed first data payload to the first application.

47. The method of claim 46, wherein the transport layer stack corresponds to a Transmission Control Protocol (TCP)/Internet Protocol (IP) stack.

48. The method of claim 46, wherein the one or more rules instruct the management application to intercept delivery of data payloads from the transport layer stack based on the packet-state.

49. The method of claim 48, wherein the one or more rules instruct the management application to intercept delivery of data payloads from the transport layer stack that correspond to one or more of a set of data payload types for which the management application is configured to apply a payload type-specific decompression protocol.

50. The method of claim 49, wherein the set of data payload types includes image data payloads, audio data payloads and/or video data payloads.

51. The method of claim 46, wherein the one or more rules instruct the management application to intercept delivery of data payloads from the transport layer stack based on the device-state.

52. The method of claim 51, wherein the one or more rules instruct the management application to intercept delivery of data payloads from the transport layer stack based on a location of the UE.

53. The method of claim 52, wherein the one or more rules define a location region whereby the management application is instructed to intercept delivery of data payloads from the transport layer stack when the UE is inside the location region and the management application is instructed not to intercept delivery of data payloads from the transport layer stack when the UE is not inside the location region.

54. The method of claim 52, wherein the one or more rules define a location region whereby the management application is instructed to intercept delivery of data payloads from the transport layer stack when the LE is outside the location region and the management application is instructed not to intercept delivery of data payloads from the transport layer stack when the UE is not outside the location region.

55. The method of claim 46, wherein the one or more rules instruct the management application to intercept delivery of data payloads from the transport layer stack based on the application-state.

56. The method of claim 55, wherein the one or more rules instruct the management application to intercept delivery of data payloads from the transport layer stack that originate from a specified set of applications including the first application.

57. The method of claim 46, wherein the one or more rules instruct the management application to intercept delivery of data payloads from the transport layer stack based on the network-state.

58. The method of claim 57, wherein the one or more rules instruct the management application to intercept delivery of data payloads to the transport layer stack based on a performance or type of the serving network.

59. The method of claim 58, wherein the one or more rules instruct the management application to intercept delivery of data payloads from the transport layer stack when the performance of the serving network is below or above a threshold.

60. The method of claim 58,
wherein the one or more rules instruct the management application to intercept delivery of data payloads from the transport layer stack when the UE is connected to serving networks of a first type, and
wherein the one or more rules instruct the management application not to intercept delivery of data payloads from the transport layer stack when the UE is connected to serving networks of a second type.

61. The method of claim 60, wherein the first type includes cellular networks.

62. The method of claim 60, wherein the second type includes WiFi networks.

63. The method of claim 57, wherein the one or more rules instruct the management application to intercept delivery of data payloads from the transport layer stack based on a subscription status of the UE with the serving network.

64. The method of claim 57, wherein the one or more rules instruct the management application to intercept, delivery of data payloads from the transport layer stack based on data usage costs to be charged for the UE for accessing the serving network.

65. The method of claim 46, further comprising:
detecting a second data payload on the transport layer stack that is configured for delivery to a target application in the set of applications, wherein the second data payload is a compressed version of a data payload that originated from the target server;
determining not to intercept the delivery of the second data payload from the transport layer stack to the first application based on a failure of one or more rules from the set of rules to be satisfied for the second data payload; and
in response to the no intercept determination for the second data payload, permitting the delivery of the second data payload from the transport layer stack to the target application without intercepting the second data payload for decompression by the management application.

66. A user equipment (UE) configured to execute a management application, comprising:
means for obtaining, from a proxy server, a set of rules for selectively intercepting data from being delivered from a set of applications to a transport layer stack on the UE;
means for detecting that a given application in the set of applications is attempting to deliver a given data payload to transport layer stack on the UE for transmission to a given target server;
means for determining to intercept the delivery of the given data payload from the given application to the transport layer stack based on one or more rules from the set of rules being satisfied for the given data payload, wherein the one or more rules instruct the management application to intercept delivery of data payloads to the transport layer stack based on (1) a packet-state related to a type of the given data payload, (ii) a device-state associated with the UE, (iii) an application-state associated with the given application and/or (iv) a network-state associated with a serving network of the UE; and
means for, in response to the intercept determination for the given data payload, intercepting the delivery of the given data payload from the given application to the transport layer stack, modifying the intercepted given data payload to conform to a protocol used for communications between the management application and the proxy server, and transmitting the modified intercepted given data payload to the proxy server.

67. A proxy server, comprising:
means for determining a set of applications configured for execution on a user equipment (UE);
means for determining a set of rules to be enforced by a management application on the UE, wherein each rule in the set of rules is configured to manage whether to intercept data between the set of applications and a transport layer stack for data payload modification, wherein the set of rules includes one or more rules that instruct the management application to selectively intercept the data based on (i) a packet-state related to a data payload of the data (ii) a device-state associated with the UE, (iii) an application-state associated with an application from which the data originates or to which the data is targeted and/or (iv) a network-state associated with a serving network of the UE; and
means for delivering the set of rules to the UE for enforcement by the management application.

68. A user equipment (UE) configured to execute a management application, comprising:
means for obtaining, from a proxy server, a set of rules for selectively intercepting data from being delivered from a transport layer stack on the UE to a set of applications on the UE;
means for detecting a given data payload on the transport layer stack that is configured for delivery to a given application in the set of applications, wherein the given data payload is a compressed version of a data payload that originated from a target server;
means for determining to intercept the delivery of the given data payload from the transport layer stack to the given application based on one or more rules from the set of rules being satisfied for the given data payload, wherein the one or more rules instruct the management application to intercept delivery of data payloads from the transport layer stack based on (i) a packet-state related to a type of the given data payload, (ii) a device-state associated with the UE, (iii) an application-state associated with the given application and/or (iv) a network-state associated with a serving network of the UE; and
means for, in response to the intercept determination for the given data payload, intercepting the given data payload from delivery from the transport layer stack to the given application, decompressing the intercepted given data payload to produce the data payload that originated from the target server and delivering the decompressed given data payload to the given application.

69. A user equipment (UE) configured to execute a management application, comprising:
logic configured to obtain, from a proxy server, a set of rules for selectively intercepting data from being delivered from a set of applications to a transport layer stack on the UE;
logic configured to detect that a given application in the set of applications is attempting to deliver a given data payload to the transport layer stack on the UE for transmission to a given target server;
logic configured to determine to intercept the delivery of the given data payload from the given application to the transport layer stack based on one or more rules from the set of rules being satisfied for the given data payload, wherein the one or more rules instruct the management application to intercept delivery of data payloads to the transport layer stack based on (i) a packet-state related to a type of the given data payload, (ii) a device-state associated with the UE, (iii) an application-state associated with the given application and/or (iv) a network-state associated with a serving network of the UE; and
logic configured to, in response to the intercept determination for the given data payload, intercept the delivery of the given data payload from the given application to the transport layer stack, modify the intercepted given data payload to conform to a protocol used for communications between the management application and the proxy server, and transmit the modified intercepted given data payload to the proxy server.

70. A proxy server, comprising:
logic configured to determine a set of applications configured for execution on a user equipment (UE);
logic configured to determine a set of rules to be enforced by a management application on the UE, wherein each rule in the set of rules is configured to manage whether to intercept data between the set of applications and a transport layer stack for data payload modification, wherein the set of rules includes one or more rules that instruct the management application to selectively intercept the data based on (i) a packet-state related to a data payload of the data (ii) a device-state associated with the UE, (iii) an application-state associated with an application from which the data originates or to which the data is targeted and/or (iv) a network-state associated with a serving network of the UE; and
logic configured to deliver the set of rules to the UE for enforcement by the management application.

71. A user equipment (UE) configured to execute a management application, comprising:
logic configured to obtain, from a proxy server, a set of rules for selectively intercepting data from being delivered from a transport layer stack on the UE to a set of applications on the UE;
logic configured to detect a given data payload on the transport layer stack that is configured for delivery to a given application in the set of applications, wherein the given data payload is a compressed version of a data payload that originated from a target server;
logic configured to determine to intercept the delivery of the given data payload from the transport layer stack to the given application based on one or more rules from the set of rules being satisfied for the given data payload, wherein the one or more rules instruct the management application to intercept delivery of data payloads from the transport layer stack based on (i) a packet-state related to a type of the given data payload, (ii) a device-state associated with the UE, (iii) an application-state associated with the given application and/or (iv) a network-state associated with a serving network of the UE; and
logic configured to, in response to the intercept determination for the given data payload, intercept the given data payload from delivery from the transport layer stack to the given application, decompress the intercepted given data payload to produce the data payload that originated from the target server and deliver the decompressed given data payload to the given application.

72. A non-transitory computer-readable medium containing instructions stored thereon, which, when executed by a user equipment (UE) configured to execute a management application, cause the UE to perform operations, the instructions comprising:
at least one instruction for causing the UE to obtain, from a proxy server, a set of rules for selectively intercepting data from being delivered from a set of applications to a transport layer stack on the UE;
at least one instruction for causing the UE to detect that a given application in the set of applications is attempting to deliver a given data payload to the transport layer stack on the UE for transmission to a given target server;
at least one instruction for causing the UE to determine to intercept the delivery of the given data payload from the given application to the transport layer stack based on one or more rules from the set of rules being satisfied for the given data payload, wherein the one or more rules instruct the management application to intercept delivery of data payloads to the transport layer stack based on (i) a packet-state related to a type of the given data payload, (ii) a device-state associated with the UE, (iii) an application-state associated with the given application and/or (iv) a network-state associated with a serving network of the UE; and
at least one instruction for causing the UE to, in response to the intercept determination for the given data payload, intercept the delivery of the given data payload from the given application to the transport layer stack, modify the intercepted given data payload to conform to a protocol used for communications between the management application and the proxy server, and transmit the modified intercepted given data payload to the proxy server.

73. A non-transitory computer-readable medium containing instructions stored thereon, which, when executed by a proxy server, cause the proxy server to perform operations, the instructions comprising:
at least one instruction for causing the proxy server to determine a set of applications configured for execution on a user equipment (UE);
at least one instruction for causing the proxy server to determine a set of rules to be enforced by a management application on the UE, wherein each rule in the set of rules is configured to manage whether to intercept data between the set of applications and a transport layer stack for data payload modification, wherein the set of rules includes one or more rules that instruct the management application to selectively intercept the data based on (i) a packet-state related to a data payload of the data (ii) a device-state associated with the UE, (iii) an application-state associated with an application from which the data originates or to which the data is targeted and/or (iv) a network-state associated with a serving network of the UE; and
at least one instruction for causing the proxy server to deliver the set of rules to the UE for enforcement by the management application.

74. A non-transitory computer-readable medium containing instructions stored thereon, which, when executed by a user equipment (UE) configured to execute a management application, cause the UE to perform operations, the instructions comprising:
at least one instruction for causing the UE to obtain, from a proxy server, a set of rules for selectively intercepting data from being delivered from a transport layer stack on the UE to a set of applications on the UE;
at least one instruction for causing the UE to detect a given data payload on the transport layer stack that is configured for delivery to a given application in the set of applications, wherein the given data payload is a compressed version of a data payload that originated from a target server;
at least one instruction for causing the UE to determine to intercept the delivery of the given data payload from the transport layer stack to the given application based on one or more rules from the set of rules being satisfied for the given data payload, wherein the one or more rules instruct the management application to intercept delivery of data payloads from the transport layer stack based on (i) a packet-state related to a type of the given data payload, (ii) a device-state associated with the UE, (iii) an application-state associated with the given application and/or (iv) a network-state associated with a serving network of the UE; and
at least one instruction for causing the UE to, in response to the intercept determination for the given data payload, intercept the given data payload from delivery from the transport layer stack to the given application, decompress the intercepted given data payload to produce the data payload that originated from the target server and deliver the decompressed given data payload to the given application.
